(19) United States
(12) Patent Application Publication
(10) Pub. No.: US 2005/0046886 A1
(43) Pub. Date: Mar. 3, 2005

(54) Direct printing component architecture for installed printers

(75) Inventor: Andrew R. Ferlitsch, Tigard, OR (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/650,220

(22) Filed: Aug. 28, 2003

(51) Int. Cl. G06F 15/00

(52) U.S. Cl. 358/1.13; 358/1.15

(57) ABSTRACT

A driverless direct-printing method between a client computer and a direct-printing-enabled printer. A working relationship for direct printing is established through a set of dynamically configurable modules whose conditions for document native-format direct printing are established from printer data in database structure which has been pre-collected, at least in part, by a printer discovery process. Aside from the presence of a printer discovery module which helps to populate the database structure just mentioned, other configurable modules include a print menu selection module, a job control generation module, a print job construction nodule, and a scheduling/spooling/despooling module.

### BACKGROUND AND SUMMARY OF THE INVENTION

This invention relates to a printing (or more generally imaging) system and methodology, referred to collectively as architecture, which focus on driverless direct printing (DP) of a document in its native format. The invention features an adaptive universality quality in its ability accurately and dynamically to establish a precision working “fit” between a client computer and a DP-enabled printer. The invention promotes such printing via the use of a unique generalized print subsystem which is installed in a client computer in the form of several dynamically configurable modular components that become configured, in accordance with practice of the invention, for operation with a connected, DP-enabled printer.

This invention thus, by resolving dynamically the issue of cooperative compatibility between a computing device and a printer, without requiring dedicated, detailed and costly construction and implementation of myriad specialized DP interfaces between such devices, introduces an important advance in the practice of digital direct printing. Notably, it does this in a manner which assures a precision alignment between a computing device and a DP-enabled printer in relation (a) to all relevant and current capabilities of that printer, (b) to all settings associated therewith, and (c) to the correctness of needed communication protocols.

Accordingly, and as will be seen, the invention proposes the installation, in a subject client computer, of an appropriate set of rapidly, dynamically and redoably configurable modules, which, during practice of the invention to send a print job of a document or image in its native format to a DP-enabled printer, become precisely configured for that printer based upon information contained, at least in part, in a discovery-based, pre-created database (also referred to herein as a printer-instance database) which “describes” (among other things) the actual current characteristics, and the associated settings, of the subject printer.

In the preferred and best-mode form of the invention, five principal, configurable modules are provided and employed. These include (1) a printer discovery module, (2) a print menu generation module, (3) a job control generation module, (4) a print job construction module, and (5) a scheduling/spooling/despooling module. The various specific natures of, and tasks performed by, these modules are described below, and are illustrated, in the detailed description of the invention and in the drawings.

Cooperating with the operations of these modules in the practice of the invention is an earlier-created printer model database which at least contains accurate information preferably about how to communicate correctly (the proper communication protocols) with the full model-range of DP-enabled printers with which the client computer may become engaged in direct-printing activities. This printer-model database may include other specific information about various printers, and such other information may, as will soon become apparent herein, minimize the amount of discovery gathering required by the printer discovery module in relation to the printers associated with that information.

Module configuration for job implementation is performed dynamically on-the-fly, and as a document job-printing request is received by the associated client computer, with reference to a pre-established DP-enabled printer-instance database which has been created for that computer. This printer-instance database is generated from a previously implemented printer discovery process under the control of the printer discovery module. In this discovery process, available, operatively connected and DP-enabled printers are identified, and important, current-printer-specific (printer-instance) data is gathered. In particular, and to the extent not available from the mentioned printer-model database, data is gathered to inform the inquiring client computer about each such printer's respective (a) currently installed and specifically available printing characteristics, and (b) operational settings that are required/offered to implement these characteristics. Communication to accomplish this takes place correctly for each involved printer because of the printer-model information (mentioned above) contained in the installed printer-model database.

These and other important features of, and advantages which are offered by, the present invention, both systemic and methodologic, will become more fully apparent as the description which now follows is read in conjunction with the accompanying drawings.

### DESCRIPTION OF THE DRAWINGS

FIG. 1 is a simplified block/schematic diagram illustrating the preferred and best-mode structure and practice of the present invention.

FIG. 2A provides a block/schematic view of the practice of the present invention which relates to the mentioned discovery process, and to the printer-instance database creating activities, of the invention.

FIG. 2B is related to FIG. 2A, and provides a block/schematic view of DP job-handling practice of the invention which includes module configuration on-the-fly, and then native-format, direct, document-job printing of the associated job document.

FIG. 3 is a more elaborate similar view of the invention.

FIG. 4 provides yet another block/schematic view of the present invention structured with a printer-driver-based influence.

FIG. 5 offers still a further block/schematic invention view which is structured with a printer-model-based influence.

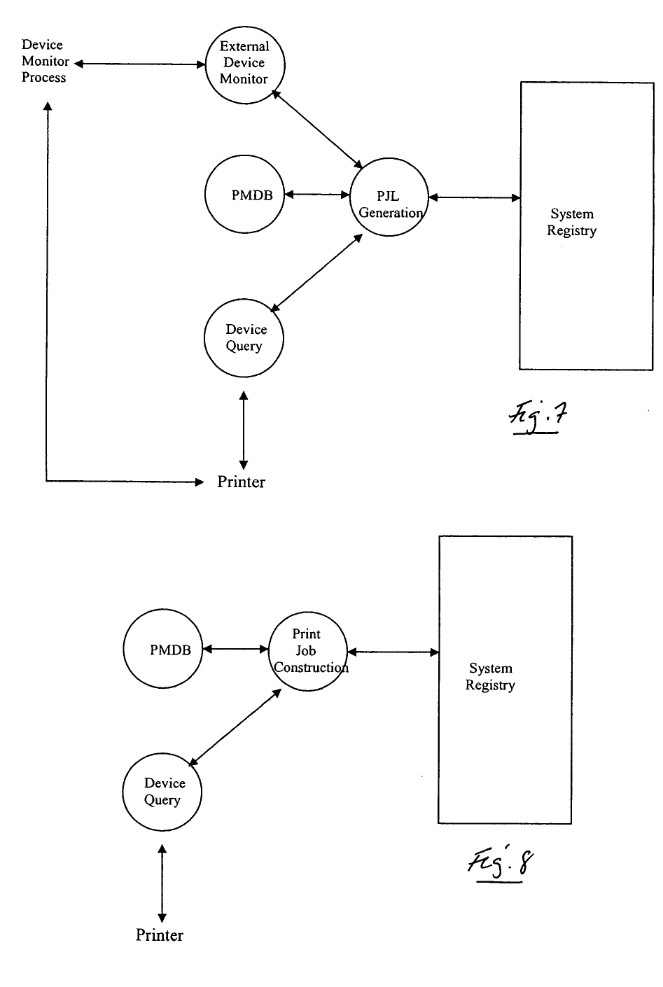

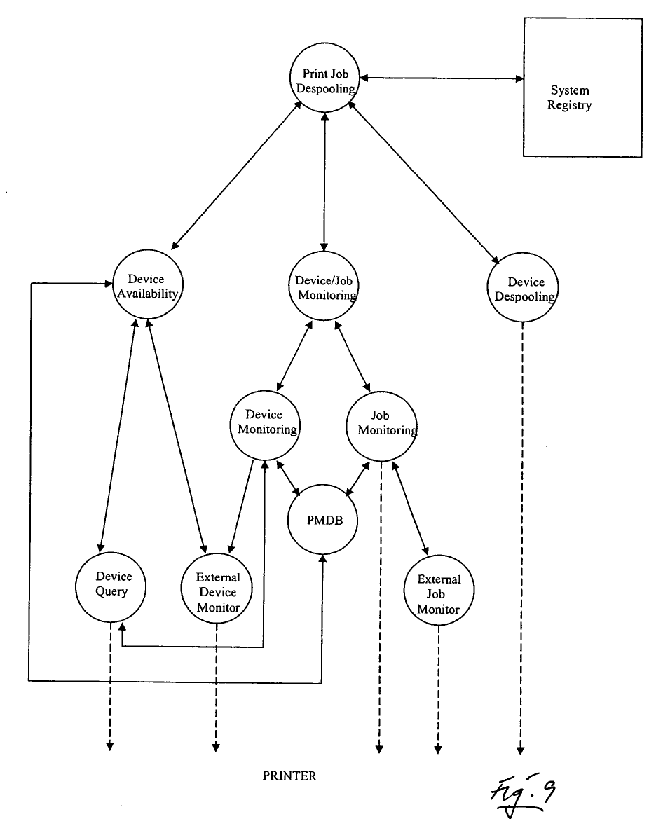

FIGS. 4 and 5 additionally illustrate the make-up and operation of the earlier-mentioned DP-enabled printer discovery module.

FIG. 6 is useful in visualizing the construction and operation of the print menu generation module.

FIG. 7 describes how to visualize the construction and operation of the print job control generation module.

FIG. 8 illustrates the print job construction module.

FIG. 9 shows the structure and operation of the scheduling/spooling/despooling module.

### DETAILED DESCRIPTION OF THE INVENTION

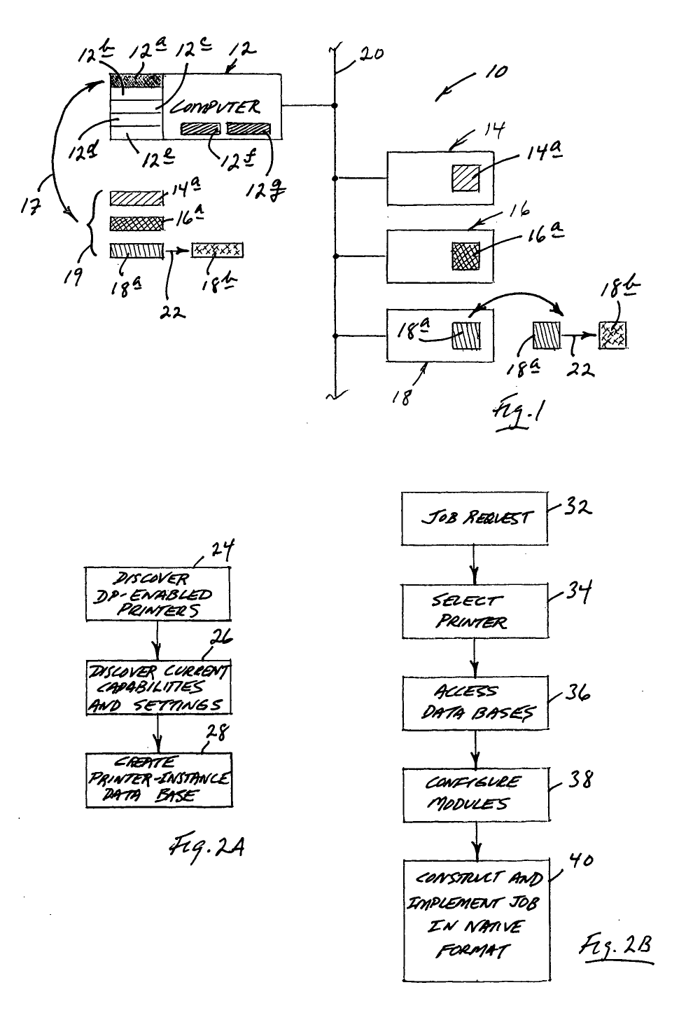

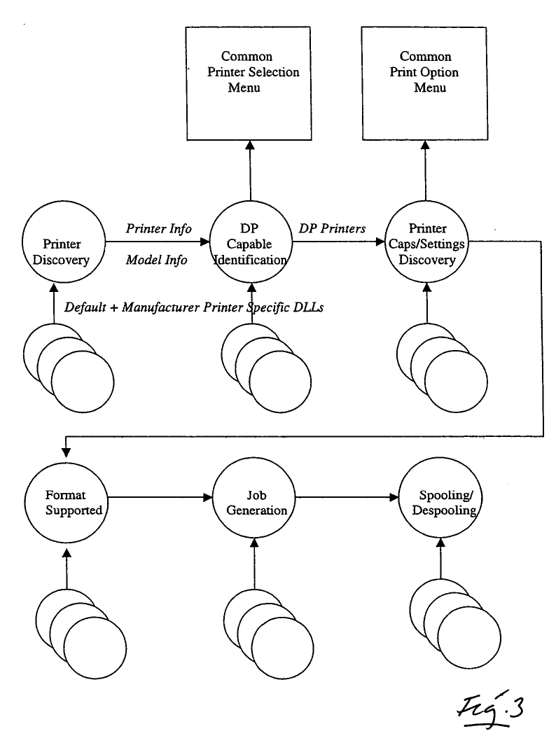

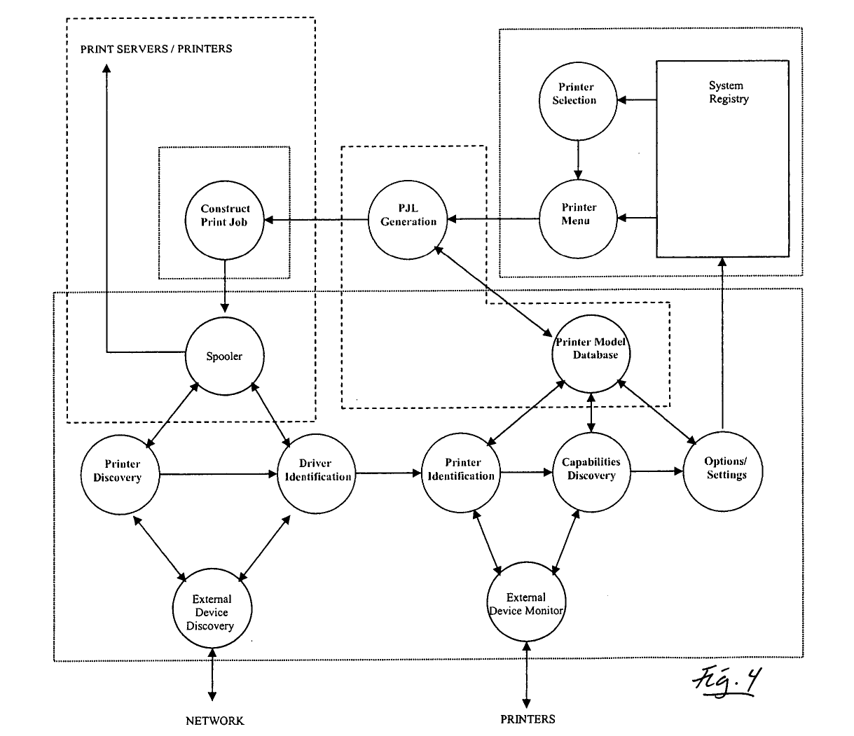

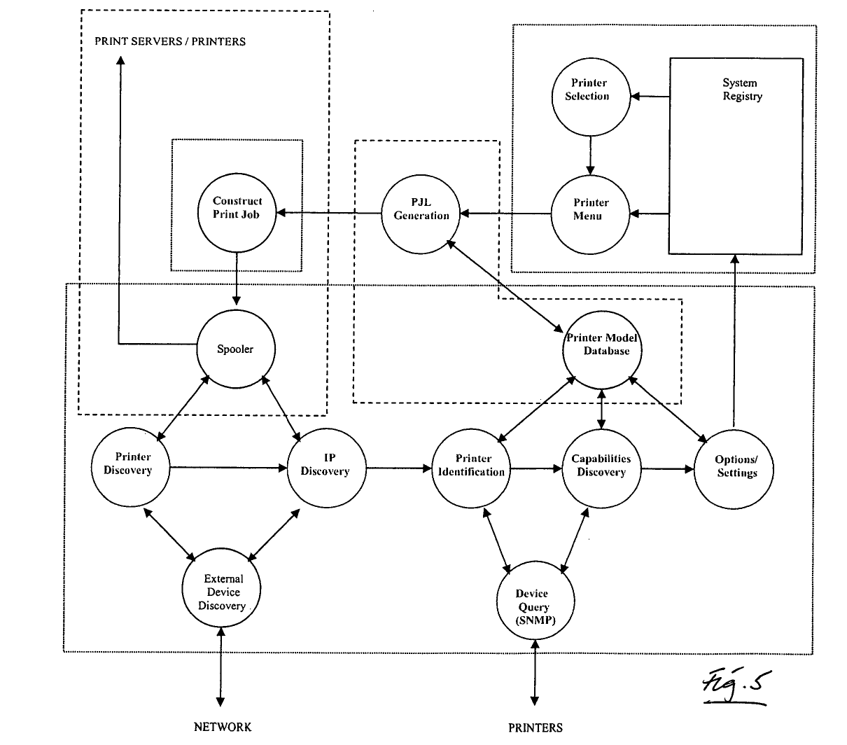

Turning now to the drawings, and referring first to FIGS. 1, 2A and 2B, indicated generally at 10 in FIG. 1 is a communication network which includes a computer 12, referred to herein as a client computer, three direct-printing (DP)-enabled printers 14, 16, 18, and an appropriate communication medium 20 which may take the form of any suitable network structure that produces an operative connection between computer 12 and printers 14, 16, 18. It should be understood that, while the preferred and best-mode form of the invention is illustrated in FIG. 1 in a network setting, interconnection between computer 12 and printers 14, 16, 18 does not in any way depend upon the presence of a network in relation to how the present invention performs. Rather, illustration in the setting of a network provides merely an example of an environment wherein the structure and methodology of the present invention have particular utility.

Included within computer 12 in accordance with the present invention are five, special, rapidly dynamically reconfigurable modules 12a, 12b, 12c, 12d, 12e. These modules 12a-12e, inclusive, are, respectively, the previously mentioned printer discovery module, the print menu generation module, the job control generation module, the print job construction module, and the scheduling/spooling/despooling module. Further included in computer 12 are a pre-installed printer-model database 12f, having the characteristics mentioned earlier herein, and a printer-instance database 12g which becomes created in accordance with practice of the present invention involving operation of printer discovery module 12a.

In each of the three blocks which represent printers 14, 16, 18 there appears a small shaded rectangle, with the shadings for the three thus-included rectangles being different from one another to highlight the fact that they are different. For printers 14, 16, 18, these shaded rectangles are illustrated in FIG. 1 at 14a, 16a, 18a, respectively. Rectangles 14a, 16a, 18a represent information contained in the respective printers which relates to the respective, (a) currently installed capabilities and characteristics of the printers, and (b) the so-called settings which are relevant to those capabilities. In other words, the information contained in blocks 14a, 16a, 18a precisely defines just what are the currently useable, installed capabilities and characteristics of these printers.

In accordance with a preferred manner of practicing the invention, at any appropriate time or times, either automatically or under specific user control, a discovery process is initiated by computer 12 utilizing module 12a to learn of the identities of DP-enabled printers to which it is operatively connected, and with respect to each such printer, essentially all of the information contained in “information rectangles”, like rectangles 14a, 16a, 18a. Computer 12 stores this printer-specific information in previously mentioned printer-instance database 12g. In a double-headed curved arrow 17, and by way of a bracket 19, both of which are positioned toward the left side of FIG. 1, three elongate, shaded rectangles, labeled 14a, 16a, 18a, symbolize this discovery information-gathering activity.

It is, of course, important to the practice of the present invention that this printer discovery process be capable, under all circumstances, of detecting accurately the contents of blocks 14a, 16a, 18a, even where that content may change at some point or points in time with respect to added or changed printer capabilities, etc. Toward the lower right side of FIG. 1, and in conjunction with printer 18, one will see that there is provided another small shaded rectangle 18b which is connected by an arrow 22 that extends to this block 18b from an off-board representative of previously-discussed information block 18a. This is presented in FIG. 1 in order to illustrate generally a change which may take place with regard to the printer-specific data and information originally contained in block 18a. Representations of block 18b and arrow 22 are also shown at the left side of FIG. 1. As will be seen, it is a capability of the present invention to follow and modify its print-specific, printer-instance database, in order to take into account any such data or information change in a block like block 18a, which enables practice of this invention to progress speedily and accurately when called upon to implement a direct-printing job request.

Turning attention now to FIGS. 2A, 2B along with FIG. 1, FIG. 2A describes generally the DP-enabled printer discovery process mentioned above. This process which, as was mentioned earlier, may be implemented in a number of different ways and at different times, begins (block 24) with a basic discovery of the presences and identities of DP-enabled printers, such as printers 14, 16, 18. Following discovery and identification of available, operatively connected printers, computer 12 requests and discovers all of the current relevant performance capabilities and associated settings, (block 26). This discovery-gathered information is then employed to create printer-instance database (block 28).

FIG. 2B represents what takes place regarding the operation of computer 12 when a document job-printing request (block 32) is made. Based upon information contained in databases 12f, 12g within computer 12, computer 12 selects the most appropriate printer (block 34) and then, on-the-fly, and utilizing information in the databases (block 36), configures the appropriate modules (block 38) in the collection of modules (12b-12e, inclusive) which have been generally pre-established as functional components in computer 12. When module configuration is complete, printer 12 constructs and implements printing of the requested document print job (block 40)—handling this job on a direct printing basis, and utilizing the job document's native format.

FIGS. 2A, 2B, thus, provide a comprehensive general overview of the structure and operation of the present invention in the setting of a communication arrangement like that shown for network 10 in FIG. 1.

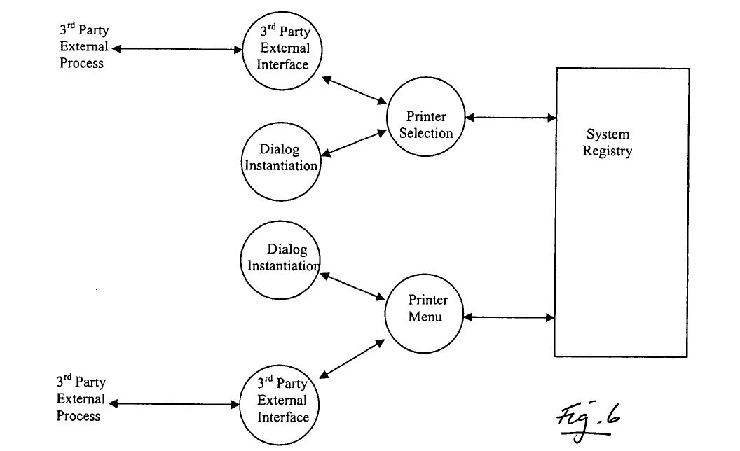

While FIGS. 1, 2A and 2B generally and fully illustrate the structure and methodology of the present invention, a narrative description relating to the invention now continues at a somewhat more detailed level, with references now made to FIGS. 3-9, inclusive. Those skilled in the art will recognize, from the ways that information is presented in FIGS. 3-9, inclusive, that these figures fully enable one to implement and practice the present invention.

FIG. 3 provides another overview of the system and methodology of this invention. Labeling that is provided in this figure generally illustrates the presences of various ones of the configurable modules 12a-12e, inclusive. Each module is implemented as a DLL with a standard API interface, and each has one or more default methods for carrying out its corresponding function. For example, the default method for printer discovery is to use a search for local/network installed printers. The default method for capability discovery (relative to discovered printers) involves use of a PMDB database in conjunction with SNMP for installable and installed options regarding printers.

It is, as was mentioned earlier, the discovered information relating to printer capabilities and settings that, in conjunction with printer-model information present in database 12f, sets the stage for computer 12 to perform a dynamic configuration of the appropriate modules to enable the implementation of a document print job, in a direct-printing manner, and utilizing the appropriate native document format, between computer 12 and any one of printers 14, 16, 18.

Directing attention now to FIGS. 4 and 5 along with FIGS. 1, 2A, 2B, as has been mentioned earlier herein, the system of this invention is constructed from dynamically installable and configurable components that form modules. Each component has a standard interface for inter-component communication, and each module also has a standard interface for inter-module communication and control.

The DP system generally includes the following modules:
1. Printer discovery
2. Print menu generation
3. Print job control generation
4. Print job construction
5. Scheduling/spooling/despooling

Each module consists of one or more interchangeable components, with respect to which each component implements a specific function in the module, and interfaces for control and communication with the module, and with other components in the module, via a standard interface. For example, each component may implement and export a standard API that controls the invocation and operation of the component. The component may communicate back to the controlling mechanism (i.e., module) success and/or error via return codes, parameters or common memory. The component may communicate the output via shared data, as by using the system registry in the Microsoft Windows® family of operating systems. For highlighting purposes only herein, various references to components within the several modules are occasionally italicized in the text. Also a client computer is sometimes referred to herein as a computing device.

The printer discovery module includes components that perform the following functions:
1. Discovery of installed printers (also called devices).
2. Identification of printer type.
3. Identification of DP-enabled printers.
4. Discovery of DP capabilities of a printing device.
5. Discovery of DP option settings per capability of a printing device.
6. Discovery of means to communicate DP capabilities/settings back to printing device.

Generally, the printer discovery module is initiated through the installed printer discovery component. This component identifies all, or a subset, of printers which are accessible to a client computing device. For example, the installed printer discovery component might have an input interface for initiating the discovery process. This interface may also control how the component discovers installed printers. For example, this behavior might include:
1. Discovering all printers already installed on the client computing device.
2. Discovering installable printers within an associated network.

In the former case, the component would query the relevant print subsystem for all, or a subset, of installed printers. For example, in the Microsoft (MS) Windows® family of operating systems, the component could issue the print spooler API EnumnPrinters( ) to obtain a list of locally and network installed printers. In the latter case, the component could query an external discovery process that returns a list of installable printers on a network. In either case, the output of the discovery process is stored in database 12g, also referred to herein as shared data, such as the system registry in MS, and in a common format/convention

Other discovery methods, familiar to those generally skilled in the art, can be implemented by the installed printer discovery component.

After the installed printer discovery component has completed its work, components related to printer classification would then be initiated. These components fall into one of two categories which respectively perform the tasks of:
1. Collecting information used to identify a printer.
2. Analyzing the collected information to identify a printer.

For example, in one implementation, printer identification may be based on information associated with an installed printer, such as information regarding the associated printer driver. In another implementation, printer identification may be based upon information obtained from a printing device, such as the printer model. Printer identification information is then placed into the shared-data database.

Various approaches may be made in the realm of printer classification. For example, with regard to printer-driver-based practice, a driver identification component could be initiated. This component would obtain from shared data the list of discovered installed and installable printers. For each installed printer, the component could issue the print spooler API GetPrinter( ) to obtain information about that printer, including information relating to the associated printer driver. For each installable printer, the component could query an external discovery process for the corresponding printer information. The driver identification component would then add the printer driver identification information to the shared-data database.

In the example of the latter case, a network address identification component could be initiated. This component would obtain from shared data the list of discovered installed/installable printers. For each installed printer, the component could issue the print spooler API GetPrinter( ) to obtain information about that printer, including information relating to deriving the network address (e.g., IP address) of the associated port. For each installable printer, the component could query an external discovery process for the corresponding printer information. The network address identification component would then add the printer network address identification information to the shared-data database.

Where the printer driver identification is the collected information, the system could classify the printer by identifying (assuming) that the printer model of the printer is the same as the printer model associated with the printer driver. The system would obtain this association by invoking the printer model database (PMDB) component. This component contains information associated with various printer models. In this example, the PMDB component contains information regarding which printer drivers are associated with which printer models.

Where the network address of a printer is derived, the system could classify the printer by obtaining the printer model from the device. The system would obtain this information from the printer by invoking either a device query component or an external device monitor component.

In the case of a device query component, the component would query the device, using the network address and a supported device query protocol, for information relating to the device's model name. More than one device query component may exist, and a device query component may support more than one protocol. In general, the system would obtain from the PMDB information relating to the device query/management communication protocols supported by the device. The system would then dynamically configure (e.g., dynamically load library) or switch (e.g., send message to multi-protocol supported device query component) for using the supported device query/management protocol. In one example, the protocol is SNMP. In another example, the protocol is an http fetch of the device's internal web page, and the web page is scraped for the printer model name.

In the case of an external device monitor component, the component would query an external process that is monitoring the device and is able to provide information on the device, such as the printer model name.

Once a printer model is identified, the printer model information is stored in shared data.

The final step of this process is to identify which of the printers are DP-enabled printers. In one example, the printer identification component queries the PMDB component to obtain information on whether the printer model supports direct printing. Other information may be obtained, such as which document/image formats are supported for direct printing, and whether direct printing is an installable option (i.e., add-on option vs. built-in in base model). In another example, the printer identification component may obtain this information directly from the printing device by querying the device query component. In still another example, the same information could be obtained by querying an external device monitor component. Once the printers that are DP capable and/or enabled are identified, this information is stored in shared data.

After the printer identification component has completed its tasks, component(s) relating to discovering the capabilities of the DP-enabled printing devices is initiated. For example, in one implementation the capabilities of a DP-enabled printer are discovered using a device capabilities discovery component. This component may use other components to obtain information regarding the capabilities of the device. Such other components may include, as illustrations:
1. A PMDB component
2. A device query component
3. An external device monitor component

In the case of a PMDB component, the device capabilities discovery component would query the PMDB for the capabilities associated with the printer model. The returned information may also provide additional information, such as:
1. Whether capability is implemented in firmware or in a driver, and if not in a driver, whether capability can be emulated in any suitable fashion.
2. Whether capability is a standard or an installable option.
3. The nature of the available communication means provided to capability status.

In the case of a device query component, the device capabilities discovery component would initiate the device query component to query a printing device for its standard and installed capabilities. If a PMDB component was available, the device capabilities discovery component might initiate the device query component only to verify which installable options are installed (i.e., assume standard options obtained from PMDB are present).

In the case of an external device monitor component, the device capabilities discovery component would query the external device monitor component for the device's standard and installed capabilities. If a PMDB component was available, the device capabilities discovery component might only query the external device monitor component to verify which installable options are installed (i.e., assume standard options obtained from PMDB are present). A further query might inquire about the status of a capability (such as stapler out of staples).

Once a printer's capabilities are identified, those capabilities are stored in the shared-data database.

After the device capabilities discovery component has completed its work, component(s) relating to capability settings (i.e., print options) for each supported capability is (are) initiated.

For example, in one implementation the capability settings of a DP-enabled printer are discovered using a capability settings discovery component. This component may use other components to obtain information on the capability settings of the device, which may include:
1. A PMDB component
2. A device query component
3. An external device monitor component

In the case of a PMDB component, the capability settings discovery component would query the PMDB for the settings of each capability associated with the printer model.

In the case of a device query component, the capability settings discovery component would initiate the device query component to query a printing device for the settings of each supported capability. For example, the device may support an XML/SOAP schema where the device returns an XML description to the device query component that identifies each capability and the associated setting.

In the case of an external device monitor component, the capability settings discovery component would query the external device monitor component for the device's settings of each capability.

Once the settings per capability are identified, the capability settings are stored in shared data.

Turning attention now to FIG. 6 along with FIGS. 1-4, inclusive, the print menu selection module, which also implements print menu generation, consists of components that perform the following functions:
1. Presenting a selection list of DP printers.
2. Specifying a default/selected DP printers.
3. Presenting a print menu for a specific DP printer.
4. Specifying default/selected capability settings for a specific DP printer.

Generally, the print menu selection module is initiated through the printer selection component. This component obtains from the shared-data database a list of all of the shared DP, and either:
1. Instantiates a user selection process for a user to select a printer, or
2. Passes the printer list to a third party component (i.e., external interface) for selecting a DP printer.

In the former case, the printer selection component waits for the user to make a selection, and then stores the selected DP printer in the shared-data database. In the latter case, the printer selection component waits for a response back from the third-party component, which contains the selected DP printer, and stores the selected DP printer in the shared-data database.

The selected DP printer can be stored either as the default DP printer (i.e., persists across invocations) or as the current DP printer (i.e., only for the current instance such as in a print job). The printer selection component can also be asked for the default DP printer without instantiating a dialog.

After the printer selection component has completed its tasks, the print menu component in the print menu selection module is initiated. This component obtains a list of all capabilities and associated settings for the selected DP printer (default or current) from the shared data and either:
1. Instantiates a user selection means for a user to select capability settings, or
2. Passes the capabilities/settings to a third party component (i.e., external interface) for selecting the capability settings.

In the former case, the print menu component populates a print menu according to the obtained capabilities and settings of the selected DP printer. For example, in an MS Windows® dialog, a list control may be added for each capability, where the list contains the associated settings. The user could select a setting by clicking on the list to pull down the selection list, and then by clicking on one of the settings. The print menu component waits for the user to make the selections, and stores selected settings per capability in the shared-data database.

In the latter case, the print menu component waits for a response back from the third-party component, which contains a list of the selected settings per capability and stores them in the shared-data database.

The selected settings per capability can be stored either as the default capability setting (i.e., persists across invocations), or as a current capability setting (i.e., only for the current instance such as in a print job). The printer menu component can also be asked for the default setting per capability without instantiating a dialog.

FIG. 7 introduces details of the print job control generation module.

This module includes components that perform the following functions:
1. Obtaining the job control command sequence (e.g., PJL) for each selected setting per capability. It is also possible here to emulate a capability in relation to generating a job control sequence.
2. Constructing a job control header for a print job.

Generally, the print job control generation module is initiated through the print job control generation component. This component obtains the print job command sequences (e.g., PJL) for specifying a capability setting to the device. This component may use other components to obtain information on the print job command sequences for the device which include:
1. A PMDB component
2. A device query component
3. An external device monitor component

In the case a PMDB component, the print job control generation component would query the PMDB for the print job control command sequence of each selected setting per capability associated with the printer model.

In the case of a device query component, the print job control generation component would initiate the device query component to query the device for print job control sequence of each selected setting per capability. For example, the printing device may support an XML/SOAP schema where the device returns a XML description to the device query component that identifies the print job command sequence for each of the device's capability settings.

In the case of an external device monitor component, the print job control generation component would query the external device monitor component for the device's print job control command sequence of each selected setting per capability.

After the print job control generation component has completed its work, a print job control assembly component is initiated. This component assembles the print job control command sequences into a print job header. The assembly may include tasks such as:
1. Performing character set conversion, such as ANSI to UNICODE.
2. Resolving conflicts, such as in a situation wherein two settings have the same print job control command, but possess conflicting values. For example, one command may specify one output tray and another may specify a different output tray.

Once completed, the print job control assembly component stores the print job header in shared data.

The print job construction module, seen in greater detail in FIG. 8, includes components that perform the following functions:
1. Determining the spool file layout for DP job submission to a selected DP printer.
2. Obtaining the data for the layout. For example:
   a. RIP header/footer
   b. Print job control header
   c. Language switch
   d. Document data
3. Assembling the data into a spool file for despooling to the DP printer.

Generally, the print job construction module is initiated through the print job control generation component. This component starts by obtaining the layout of a direct print job that is compatible with the selected DP printer. This component may obtain this information from:
1. A default template
2. A PMDB component
3. A device query component (e.g., XML/SOAP).

Set forth immediately below is an example of a direct print job layout that could be compatible with a DP printer:
RIP Header
Print Job Control Sequence
PDL Language Switch
Document/Image Data
RIP Footer

The RIP header/footer might typically be constructed based on a default layout that has nearly universal compatibility across modern digital imaging devices, such as PCL laser printers. In another case, the RIP header/footer is obtained from the PMDB component. In still another case, the layout of the RIP header may be stored in the printing device and obtained by a device query, such as an HTTP request, or an XML/SOAP schema.

Immediately now below is an illustrative example of a RIP header that is compatible with a commercially available Sharp AR-276 printing device for direct printing:
Esc %-12345X@PJL RESET
@(PJL
@PJL COMMENT SHARP DPU Printing
@PJL JOB NAME=“Direct Print—O:\ttspa\Taxi\Test\test07.tif”
@PJL SET PCNAME=“imgqalnt05”
@PJL SET DRIVERNAME=“Leopard\BBDE”
@PJL SET JOBNAME=“Direct Print—O:\ttspa\Taxi\Test\test07.tif”
@(PJL SET USERNAME=“aferlitsch”
@PJL SET IPADDRESS=“172.29.226.238:57863”
@PJL SET NOTIFYJOBEND=ON

An example of a RIP footer that is compatible with the same Sharp printer is as follows:
Esc %-12345X@PJL EOJ NAME=“Direct Print—O:\ttspa\Taxi\Test\test07.tif”Esc %-12345X

An example of a print job control sequence generated by the print job control generation module for the same above-mentioned Sharp printer is for direct printing is:
@PJL SET COPIES=2
@PJL SET COLLATE=ON
@PJL SET DUPLEX=OFF
@PJL SET ORIENTATION=PORTRAIT
@PJL SET MEDIASOURCE=AUTO
@PJL SET OUTTRAY=TRAY1
@PJL SET JOBSTAPLE=STAPLENON
@(PJL SET SUSPEND=OFF

The mentioned PDL language switch generally is either (a) constructed based on a default syntax that has nearly universal compatibility across modern digital imaging devices, such as PCL laser printers, (b) obtained from the PMDB component or (c) stored in the printing device and obtained by a device query, such as an HTTP request or an XML/SOAP schema.

Below is an example of a PDL language switch that is compatible with the same previously identified Sharp printer for the direct printing of TIFF images:
@PJL ENTER LANGUAGE=TIFF

The final step of the print job construction module is to assembly the print data components into a print job according to the print job layout. The assembled print job may then be stored either in-memory or on-disk. Once completed, the print job construction component stores the location of the print job in shared data. Print job construction may also be based on capability emulation. An example of this could involve instructions regarding the making and handling of plural page copies.

Shifting attention now additionally to FIG. 9, the print job scheduling/spooling/despooling module includes components that preferably perform the following functions:
1. Initiating the despooling of a print job to a selected DP printer.
2. Despooling a print job to a selected DP printer.
3. Completing the despooling of the print job to a selected DP printer.
4. Monitoring the completion/progress of a print job.
5. Monitoring the status of a selected DP printer.
6. Respooling held jobs.

Generally, the print job despooling module is initiated through the print job despooling component. This component starts the process by invoking the device availability component. The device availability component determines the availability of the device, such as ready, busy or in error state. The device availability component may obtain the availability status by several means, including:
1. Querying the print spooler on the availability of the local print queue.
2. Querying the port manager on the status of the connection to the selected device.
3. Querying the device via the device query component.
4. Querying an external monitor via an external device monitor component.

In the case of querying via the device query component, the device availability component might obtain from the PMDB component the method of querying the device for its availability.

If the device availability component determines that the device is not currently available, the component might:
1. Cancel the print job, or
2. Reschedule the print job when the selected device is available.

The component may decide on which of these to do either by default, by instantiating a user dialog, or by interfacing with a third-party process.

If the device availability component determines that the device is available, the print job despooling component would initiate the despooling component. This component despools the print job to the port manager associated with the printing device, and monitors the status of despooling through the port monitor. If despooling fails (e.g., connection down), the despooling component may perform some form of error recovery, including:
1. Canceling the print job.
2. Rescheduling the print job when despooling is operational.

The component may decide on which of these to do either by default, by instantiating a user dialog, or by interfacing with a third-party process.

Once a print job has been despooled, or in parallel, the print job despooling component would initiate the print job monitoring component. This component monitors the progress and completion of the print job and the status of the device during the printing of the job. This component would initiate both the device monitoring and job monitoring components.

The device monitoring component would monitor the status of the device, such as printing vs. error state. The device monitoring component is terminated by the print job monitoring component when the print job has completed, canceled or rescheduled. The device monitoring component may obtain the device status by several means, including:
1. Querying the device via the device query component.
2. Querying an external monitor via the external device monitor component.

In the case of querying via the device query component, the device monitoring component might obtain from the PMDB component the method of querying the device for its status. The method may also be event based (i.e., waiting on an interrupt) instead of polling (i.e., query).

If the device monitoring component determines that the device is not functioning, the component might:
1. Cancel the print job.
2. Reschedule the print job when the selected device is functioning.
3. Wait until that device is functioning.

The component may decide on which of these to do either by default, by instantiating a user dialog, or by interfacing with a third party process.

The job monitoring component would monitor the status of the print job on the device, such as printing vs. job completion. The job monitoring component is terminated by the print job monitoring component when the print job has completed, or been canceled or rescheduled. The job monitoring component may obtain the job status by several means, including:
1. Querying the selected device via the device query component.
2. Querying an external monitor via the external job monitor component.

In the case of querying via the device query component, the job monitoring component might obtain from the PMDB component the method of querying the device for the status of a job. The method may also be event based (i.e., waiting on an interrupt) instead of polling (i.e., query).

Thus the present invention is described and illustrated in detail. Direct printing print jobs are handled in a fashion wherein readily dynamically configurable modules prepare themselves for accurate, matching interrelation with a selected printer. A print job is performed accurately with and by a selected printer whose operational characteristics, capabilities, and related settings have been discovered, at least in part, by a printer discovery process which is practiced in accordance with the invention.

Variations and modifications of the invention are certainly possible, and may be made without departing from the spirit of the invention.

1. A driverless direct-printing method implementable between a client computer and a selectable direct-printing-enabled printer which is operatively connected to the computer, said method comprising
utilizing the client computer, discovering, with respect to such printer, the actual, current printing capabilities thereof, and the related printing settings associated therewith, required for client-computer invocation of those capabilities and settings, and
at a point in time following that discovering, and on the occurrence of a request to the client computer for the undertaking of a direct-printing print job regarding a selected job document having an associated native format, appropriately dynamically configuring the client computer to generate, prepare and communicate that job document, in its native format, for direct printing by that printer utilizing the discovered actual current printing capabilities and related, associated settings for that printer.

2. A driverless method implementable by a client computer in an associated network to enable client-invoked direct printing of a print-job document in its native format by a selected one of accessible direct-printing-enabled printers comprising
initiating, from the client computer, a printer-information discovery process to ascertain (a) the identities of any such network-connected printers, and (b) the actual, specific, current performance capabilities and related operational settings, of the respective, so-identified printers,
following said initiating and ascertaining, creating an identified-printer database containing the respective ascertained capabilities and settings, and
on the basis of a request being placed with the client computer for the implementation of a direct-printing job regarding a selected job document which has an associated native format, and utilizing printer-specific information regarding capabilities and settings contained in the created database, dynamically configuring, generating and communicating that job document, in its native format, for direct printing by a selected one of the identified printers.

3. The method of claim 2, wherein said configuring, generating and communicating are collectively enabled/accomplished (1) by the pre-constructing, for use in and by the client computer, of a collection of available, dynamically configurable, inter-relatable, direct-printing-associated functional modules including (a) a printer discovery module, (b) a print menu selection module, (c) a job control generation module, (d) a print job construction module, and (e) a scheduling/spooling/despooling module, and (2) by then dynamically configuring and employing these modules, as appropriate, and in relation to information contained in the created database, to effect the carrying out of the requested direct-printing job.
